(19) United States
(12) Patent Application Publication
(10) Pub. No.: US 2013/0162567 A1
(43) Pub. Date: Jun. 27, 2013

(54) METHOD FOR OPERATING TOOL LIST AND PORTABLE ELECTRONIC DEVICE USING THE SAME

(71) Applicant: Woei-Luen Perng, Taipei City (TW)

(72) Inventor: Woei-Luen Perng, Taipei City (TW)

(21) Appl. No.: 13/719,236

(22) Filed: Dec. 19, 2012

(30) Foreign Application Priority Data
Dec. 23, 2011 (TW) 100148319

(51) Int. Cl. G06F 3/01; G06F 3/041

(52) U.S. Cl. CPC G06F 3/017; G06F 3/041
USPC 345/173; 345/156

(57) ABSTRACT

A method for operating a tool list applied to a portable electronic device is provided. The portable electronic device comprises a display surface including an operation area and a tool control area. The tool control area includes a tool list for receiving a tool selection signal. The method for operating the tool list includes following steps: receiving a first control signal by the display surface, wherein the first control signal is different from the tool selection signal, and disabling the tool list according to the first control signal. A portable electronic device using the method described above is also disclosed.

### CROSS-REFERENCE TO RELATED APPLICATION

This application claims the priority benefit of Taiwan application serial No. 100148319, filed on Dec. 23, 2011. The entirety of the above-mentioned patent application is hereby incorporated by reference herein and made a part of specification.

### BACKGROUND OF THE INVENTION

1. Field of the Invention

The invention relates to an operating method and, more particularly, to a gesture operating method applied to a portable electronic device.

2. Description of the Related Art

Various portable electronic devices are flourishing in modern life as they are portable and space-saving. Taking a tablet computer, a personal digital assistant (PDA) or a smart phone as an example, the portable device not only has communication functions, but also can provide a Windows operation system for the user to write documents, receive and send an E-mail, surf the Internet or use instant message software. Thus, the portable electronic device can provide various functions like a mini personal computer. Moreover, as wireless network technology develops, people in modern society are more likely to use the functions anytime and anywhere in pursuit of efficiency and time management.

Additionally, as pointing stick and touch pad technology develops, manufacturers of electronic products, such as a notebook computer, a mobile phone or a portable media player, tend to replace a conventional keyboard with a touch control screen used as an inputting interface. Taking a traditional mobile phone as an example, the user needs to look at the display screen while he or she is pressing the keyboard to input words or select an option. However, if the user uses a mobile phone with a touch control screen, he or she can use fingers or a stylus to input words or open an application program at the screen directly. Thus, the touch control screen is more flexible and convenient in inputting.

### BRIEF SUMMARY OF THE INVENTION

A method for operating a tool list applied to a portable electronic device is disclosed. The portable electronic device includes a display surface including an operation area and a tool control area. The tool control area includes a tool list for receiving a tool selection signal. The method for operating the tool list includes following steps: receiving a first control signal by the display surface, wherein the first control signal is different from the tool selection signal, and disabling the tool list according to the first control signal.

A portable electronic device includes a touch control screen, a casing, a storage unit and a central processing unit (CPU). The casing includes a display surface, the display surface includes a screen frame for disposing the touch control screen, and the touch control screen and the screen frame form the display surface. The display surface includes an operation area and a tool control area. The tool control area includes the screen frame and a part of a peripheral area of the touch control screen. The tool control area also includes a tool list for receiving a tool selection signal. The storage unit stores a control program. The CPU is connected to the storage unit. When the display surface receives a first control signal which is different from the tool selection signal, the CPU retrieves the control program to disable the tool list according to the first control signal transmitted by the tool control area.

In sum, a control signal received at a tool control area can be generated via a touch control action, such as a press on one or more keys or a physical moving state of the whole portable electronic device sensed by a dynamical sensing unit to disable or enable the tool list at the tool control area accordingly. Thus, when the user touches a sensing device in the tool control area by mistake in operating application programs at the operation area, the application programs in execution would not be stopped. The user can disable or enable the tool list anytime according to requirements, which improves the convenience in operating the portable electronic device and facilitates the control.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a portable electronic device in an embodiment;

FIG. 2 is a schematic diagram showing a portable electronic device in another embodiment;

FIG. 3 is a flow chart showing a method of disabling a tool list in an embodiment;

FIG. 4 is a flow chart showing a method of disabling a tool list in another embodiment;

FIG. 5 is a flow chart showing a method of enabling a tool list in an embodiment; and

FIG. 6 is a flow chart showing a method of enabling a tool list in another embodiment.

### DETAILED DESCRIPTION OF THE EMBODIMENTS

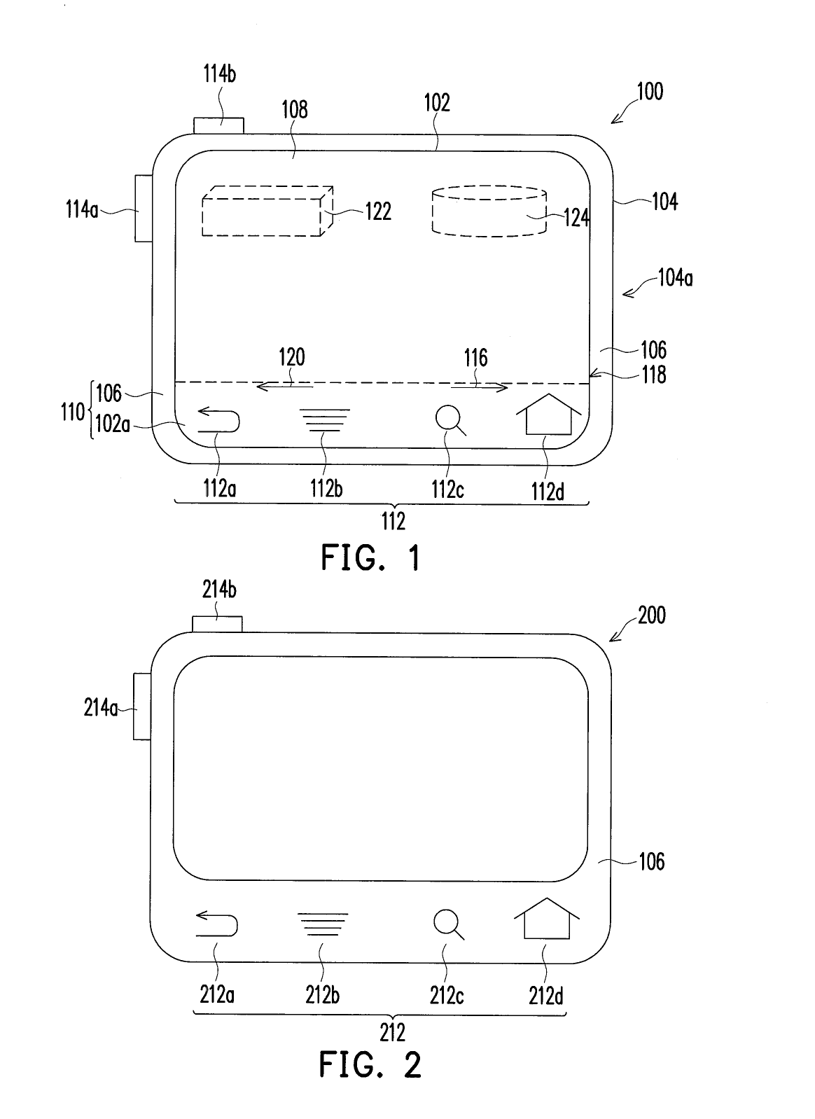

FIG. 1 is a schematic diagram showing a portable electronic device in an embodiment. Please refer to FIG. 1, in the embodiment, a tablet computer is taken as an example, the portable electronic device may be a tablet computer, a smart phone or a PDA, which is not limited herein.

A portable electronic device 100 includes a touch control screen 102 and a casing 104. A display surface 104a of the portable electronic device 100 includes a screen frame 106 and the touch control screen 102. The touch control screen 102 is disposed at the screen frame 106. The display surface 104a includes an operation area 108 and a tool control area 110.

The tool control area 110 includes the screen frame 106 and a part of a peripheral area 102a of the touch control screen. The operation area 108 is the other part of the touch control screen except the screen frame 106 and the peripheral area 102a of the touch control screen. The tool list 112 is at the tool control area 110, as the peripheral area 102a shown in FIG. 1.

In the embodiment, the tool list 112 includes a plurality of options, as shown in FIG. 1. The functions of the options include returning to home 112a, returning to previous page 112b, searching 112c or listing other operations 112d. The options can be selected to execute corresponding functions according to a tool selection signal.

In the embodiment, the tool list 112 is at a part of the peripheral area 102a of the touch control screen in the tool control area 110, which is not limited herein.

FIG. 2 is a schematic diagram showing a portable electronic device in another embodiment. Please refer to FIG. 2, in the embodiment, the tool list 212 of the portable electronic device 200 is at the touch control area of the screen frame 106, and each option of the tool list 212 (such as the options 212a, 212b, 212c and 212d) is a touch control key. In the embodiment shown in FIG. 1 and FIG. 2, the options of the tool list are virtual keys or touch control keys, which is not limited herein. The options of the tool list may also be physical key 214a and 214b disposed at the screen frame.

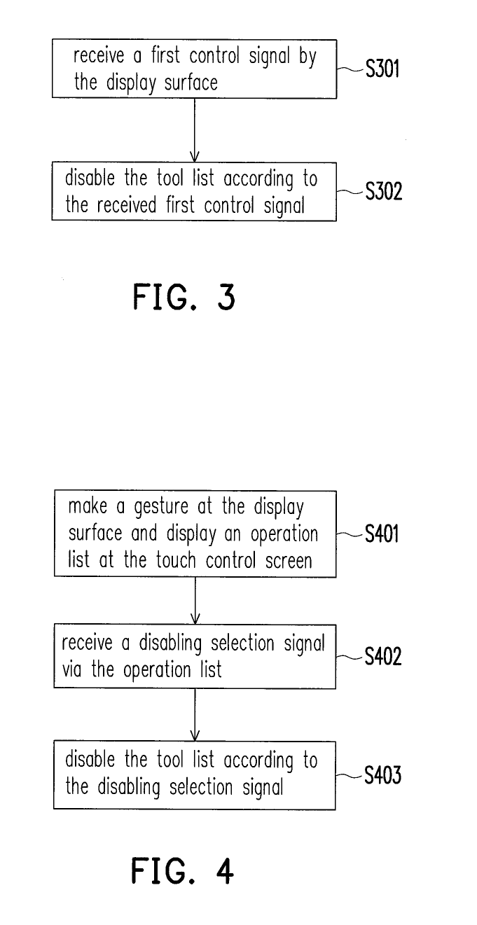

FIG. 3 is a flow chart showing a method of disabling a tool list in an embodiment. Please refer to FIG. 3, the method for operating the tool list in the embodiment can be applied to the portable electronic devices 100 and 200. In step S301, a first control signal is received at the display surface (which includes the operation area 108 and the tool control area 110). The first control signal is different from a tool selection signal, and the tool selection signal is inputted by selecting an option (such as the options 112a, 112b, 112c and 112d in FIG. 1 or the options 212a, 212b, 212c and 212d in FIG. 2) of the tool list. Then, in step S302, the tool list is disabled according to the received first control signal, that is, the tool selection signal cannot be inputted.

Please refer to FIG. 1 and FIG. 3, when the first control signal is received at the operation area 108 or a part of the peripheral area 102a of the touch control screen included in the tool control area 110, the step S302 is executed, the tool list is disabled according to the first control signal, and then the tool selection signal cannot be inputted. The statement of “Disabling” shown on the portable electronic device includes fading the display of the tool list (that is, the gray value of the tool list is decreased), integrating the tool list into a background image displayed at the touch control screen, or dynamically hiding the tool list to an edge of the touch control screen, which is not limited herein.

Please refer to FIG. 2 and FIG. 3, when the tool list 212 is at a touch control area of the screen frame 106 and receiving the first control signal, the tool list is disabled according to the first control signal, which means the tool selection signal cannot be inputted via the tool list 212 (step S302). “Disabling” is shown as fading the display of the tool list (such as decreasing the backlight brightness of the tool list).

Moreover, in step S301, the first control signal is generated when a touch control gesture is sensed at a part of the peripheral area 102a of the touch control screen in the tool control area 110. In an embodiment, when the user touches at the operation area 108 or the peripheral area 102a of the touch control screen except the tool list 112 to generate a control action (such as dragging from left to right with one finger, dragging inwards with two fingers or moving downwards with two fingers at the same time), and then the control signal is generated at a part of the peripheral area 102a of the touch control screen or the operation area 108 in the tool control area 110.

When a gesture along a specific direction is made at a part of the peripheral area 102a of the touch control screen or the operation area 108, disabling the tool list in step S302 may be shown as dynamically hiding the tool list to an edge of the touch control screen along the specific direction. Taking the portable electronic device in a landscape displaying mode (as shown in FIG. 1) as an example, when the user makes a gesture along a specific direction 116 at a part of the peripheral area 102a of the touch control screen, the tool list is disabled and hidden into an edge 118 of the touch control screen 102.

FIG. 4 is a flow chart showing a method of disabling a tool list in another embodiment. Before the tool list is disabled according to the first control signal in FIG. 3, the steps shown in FIG. 4 may also be included. After the display surface receives the first control signal, such as providing a gesture at the operation area, an operation list is displayed at the touch control screen (step S401). In step S402, a disabling selection signal is received via the operation list. In step S403, the tool list is disabled according to the disabling selection signal.

In another embodiment, the first control signal can also be generated by receiving a press on at least one physical key at the screen frame of the tool control area. The user may press a physical key (such as the physical keys 114a and 114b shown in FIG. 1 and the physical keys 214a and 214b shown in FIG. 2) at the screen frame to generate one single signal or press multiple physical keys simultaneously or unsimultaneously to generate a combination of signals used as the first control signal.

In an embodiment, the portable electronic device may include a dynamical sensing unit to sense a physical moving state of the portable electronic device to generate the first control signal. In other words, when the user holds the portable electronic device and makes the portable electronic device generate a physical movement (for example, the acceleration of the portable electronic device is changed suddenly), the dynamical sensing unit senses the physical movement and generates the first control signal accordingly. The dynamical sensing unit may be a G-sensor, a gyro sensor or a compass sensor, which is not limited herein.

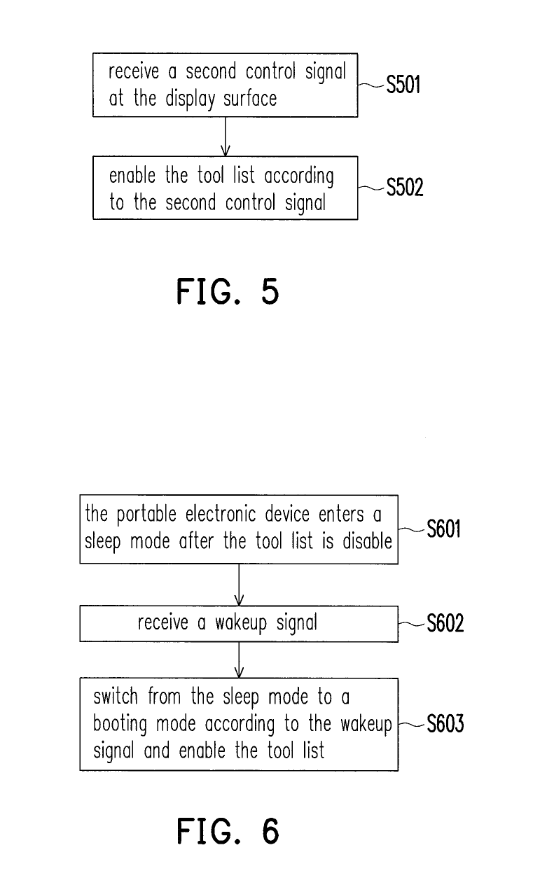

FIG. 5 is a flow chart showing a method of enabling a tool list in an embodiment. Please refer to FIG. 5, after the tool list is disabled in step S302 shown in FIG. 3, the display surface receives a second control signal (step S501). In step S502, the tool list is enabled according to the second control signal. The generation of the second control signal may be similar to that of the first control signal stated above, which is omitted herein. A touch control action sensed at the tool control area 110 to generate the second control signal and enable the tool list may be a gesture along a specific direction. The specific direction of the gesture enabling the tool list is opposite to that of the gesture disabling the tool list.

Taking the portable electronic device in a landscape displaying mode (as shown in FIG. 1) as an example, when the user makes a gesture along a first specific direction 116 at a part of the peripheral area 102a of the touch control screen in the tool control area 110 to disable the tool list and hide it into the edge 118 of the touch control screen 102, the user may make another gesture along a second specific direction 120 at a part of the peripheral area 102a of the touch control screen to enable the tool list and open the tool list from the edge 118 of the touch control screen 102, so as to display the tool list at the peripheral area 102a of the touch control screen. The first specific direction 116 is opposite to the second specific direction 120.

FIG. 6 is a flow chart showing a method of enabling a tool list in another embodiment. Please refer to FIG. 6, in the embodiment, after the tool list is disabled and the portable electronic device enters a sleep mode (step S601), a wakeup signal is received (step S602). In step S603, the sleep mode is switched to a booting mode according to the wakeup signal, and the tool list is enabled.

Please refer to FIG. 1, besides touch control screen 102 and a casing 104, the portable electronic device 100 also includes a CPU 122 and a storage unit 124 disposed in the casing 104. The storage unit 124 stores a control program. The CPU executes commands of the control program to execute the method for operating the tool list in the above embodiments, and the steps of the CPU executing reading and writing commands of the computer are the same as the steps (S301 to S302, S401 to S403, S501 to S502, S601 to S603) stated above, which are omitted herein.

In sum, a control signal received at a tool control area can be generated via a touch control action, such as a press on one or more keys or a physical moving state of the whole portable electronic device sensed by a dynamical sensing unit to disable or enable the tool list at the tool control area accordingly. Thus, when the user touches a sensing device in the tool control area by mistake in operating application programs at the operation area, the application programs in execution would not be stopped. The user can disable or enable the tool list anytime according to requirements, which improves the convenience in operating the portable electronic device and facilitates the control.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A method for operating a tool list applied to a portable electronic device, wherein the portable electronic device includes a display surface including an operation area and a tool control area, and the tool control area includes a tool list for receiving a tool selection signal, the method for operating the tool list comprising following steps:
receiving a first control signal by the display surface, wherein the first control signal is different from the tool selection signal; and
disabling the tool list according to the first control signal.

2. The method for operating the tool list according to claim 1, wherein receiving the first control signal by the display surface includes generating an operation list at the operation area according to a gesture and receiving a disabling selection signal via the operation list.

3. The method for operating the tool list according to claim 1, wherein the first control signal received by the display surface is generated at the tool control area according to a gesture.

4. The method for operating the tool list according to claim 3, wherein the display surface includes a screen frame and a touch control screen, the touch control screen is disposed in the screen frame, and the tool control area includes the screen frame and a part of a peripheral area of the touch control screen.

5. The method for operating the tool list according to claim 4, wherein the tool list is displayed at a part of the peripheral area of the touch control screen.

6. The method for operating the tool list according to claim 5, wherein disabling the tool list includes fading the display of the tool list, integrating the tool list into a background image displayed at the touch control screen, or dynamically hiding the tool list to an edge of the touch control screen.

7. The method for operating the tool list according to claim 4, wherein the tool list is at the screen frame.

8. The method for operating the tool list according to claim 1, wherein a screen frame of the tool control area includes a physical key for receiving a press to generate the first control signal.

9. The method for operating the tool list according to claim 1, wherein the portable electronic device includes a dynamical sensing unit for sensing a physical moving state of the portable electronic device to generate the first control signal.

10. The method for operating the tool list according to claim 1, wherein after the tool list is disabled, the method for operating the tool list further includes:
receiving a second control signal at the display surface; and
enabling the tool list according to the second control signal.

11. The method for operating the tool list according to claim 1, wherein after the tool list is disabled, the method for operating the tool list further includes:
receiving a wakeup signal when the portable electronic device enters a sleep mode;
switching from the sleep mode to a booting mode according to the wakeup signal and enabling the tool list.

12. A portable electronic device, comprising:
a touch control screen;
a casing, wherein the casing includes a screen frame for disposing the touch control screen, the touch control screen and the screen frame form a display surface, the display surface includes an operation area and a tool control area, the tool control area includes the screen frame and a part of a peripheral area of the touch control screen, and the tool control area also includes a tool list for receiving a tool selection signal;
a storage unit storing a control program; and
a central processing unit (CPU) connected to the storage unit, wherein when the display surface receives a first control signal which is different from the tool selection signal, the CPU retrieves the control program to disable the tool list according to the first control signal transmitted by the display surface.

13. The portable electronic device according to claim 12, wherein receiving the first control signal by the display surface includes generating an operation list at the operation area according to a gesture and receiving a disabling selection signal via the operation list.

14. The portable electronic device according to claim 12, wherein the first control signal received by the display surface is generated by a gesture along a specific direction at the tool control area.

15. The portable electronic device according to claim 12, wherein the tool list is displayed at a part of the peripheral area of the touch control screen, and disabling the tool list by the CPU according to the first control signal includes fading the display of the tool list, integrating the tool list into a background image displayed at the touch control screen, or dynamically hiding the tool list to an edge of the touch control screen.

16. The portable electronic device according to claim 12, wherein the tool list is at the screen frame.

17. The portable electronic device according to claim 12, wherein the screen frame of the tool control area includes a physical key for receiving a press to generate the first control signal.

18. the portable electronic device according to claim 12, further comprises a dynamical sensing unit for sensing a physical moving state of the portable electronic device and generating the first control signal.

19. The portable electronic device according to claim 12, wherein after the tool list is disabled, the portable electronic device further includes:
receiving a second control signal at the display surface; and
enabling the tool list by the CPU according to the second control signal.

20. The portable electronic device according to claim 12, wherein after the tool list is disabled, the portable electronic device further includes:
receiving a wakeup signal when the portable electronic device enters a sleep mode; and
switching from the sleep mode to a booting mode according to the wakeup signal and enabling the tool list.
